(19) United States
(12) Patent Application Publication
(10) Pub. No.: US 2008/0272880 A1
(43) Pub. Date: Nov. 6, 2008

(54) DEVICE WITH IC, SOC OR SIP HAVING ONE OR MORE REMOTELY ENABLED MODULE AND METHODS FOR SELLING THE DEVICE

(76) Inventors: Sehat Sutardja, Los Altos Hills, CA (US); Paul A. Lambert, Mountain View, CA (US); Saran Saund, Mountain View, CA (US); Paramesh Gopi, Cupertino, CA (US)

Correspondence Address: HARNESS, DICKEY & PIERCE P.L.C., 5445 CORPORATE DRIVE, SUITE 200, TROY, MI, 48098, US

(21) Appl. No.: 12/113,670

(22) Filed: May 1, 2008

Related U.S. Application Data
(60) Provisional application No. 61/068,769, filed on Mar. 10, 2008.
(60) Provisional application No. 61/028,718, filed on Feb. 14, 2008.
(60) Provisional application No. 60/915,779, filed on May 3, 2007.

(51) Int. Cl. G05B 19/00; G06F 7/04; H04L 9/14; H04L 9/32

(52) U.S. Cl. 340/5.2

(57) ABSTRACT

A device comprises an integrated circuit comprising N first circuit modules each having an enabled state, wherein N is an integer greater than zero and M second circuit modules each having a disabled state, wherein M is an integer greater than zero. A control module that outputs upgrade data including identification of the M second circuit modules for enabling the M second circuit modules, respectively, and that allows selection and enablement of at least one of the M second circuit modules by a purchaser based on payment of at least corresponding ones of M prices associated with said M second circuit modules.

### CROSS-REFERENCE TO RELATED APPLICATIONS

This application claims the benefit of U.S. Provisional Application No. 61/068,769, filed Mar. 10, 2008, U.S. Provisional Application No. 61/028,718, filed Feb. 14, 2008 and U.S. Provisional Application No. 60/915,779, filed on May 3, 2007. The disclosures of the above applications are incorporated herein by reference in their entirety.

### FIELD

The present disclosure relates to devices including an integrated circuit, a system-on-a-chip (SOCs), or a system-in-a-package (SIP) that includes one or more initially disabled module that can be remotely enabled.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

The cost of manufacturing integrated circuits, systems-on-a-chip (SOCs), or systems-in-a-package (SIPs) is relatively high. Suppliers attempt to decrease the unit cost of the IC, SOC or SIP by increasing production volume. However, feature sets that are requested by different device manufacturers may not be exactly the same.

One solution to this problem is to implement a separate IC, SOC or SIP for each application. However, this approach tends to increase unit cost. Another approach is to provide an IC, SOC or SIP with a basic feature set that is common with most of the intended applications. Additional features can be implemented as needed using additional ICs, SOCs, SIPs or discrete circuits. This too may be a costly approach.

Furthermore, consumers may want to purchase a device at a lowest possible price. To achieve that goal, the consumer may be required to forego one or more features of higher-priced versions of the same type of device. Later, the consumer may regret not purchasing the higher-priced version that has a particular feature. Buying another one of the devices may not be feasible.

One approach for tailoring a device for different customer applications after the device is manufactured involves the use of programmable logic devices (PLDs), complex PLDs (CPLDs) or field programmable gate arrays (FPGAs).

FPGAs are semiconductor devices that include programmable logic components or “logic blocks” and programmable interconnects. Logic blocks can be programmed to perform the function of basic logic gates such as AND, and XOR, or more complex combinational functions. In most FPGAs, the logic blocks may include memory elements, which may be simple flip-flops or more complete blocks of memory. Logic blocks and interconnects can be programmed by the customer or designer after the FPGA is manufactured to implement a desired logical function.

PLDs and CPLDs typically include one or more programmable logic arrays feeding a relatively small number of clocked registers, which reduces flexibility as compared to FPGAs. Advantages include more predictable timing delays and a higher logic-to-interconnect ratio. The FPGA architectures, on the other hand, are dominated by interconnections. This makes FPGAs far more flexible (in terms of the range of designs that are practical for implementation within them) but also far more complex to design.

To program FPGAs, PLDs and CPLDs, hardware description language (HDL) may be used to generate schematic/HDL source files. The source files are input to a software suite from a FPGA/CPLD vendor to produce a file. The file is transferred to the FPGA/CPLD via an interface such as a Joint Test Action Group (JTAG) interface or to an external memory device such as an EEPROM. Programming FPGAs, PLDs and CPLDs is not a simple task and is typically handled by highly skilled professional engineers.

FPGAs, PLDs and CPLDs are usually slower than dedicated, fixed function application-specific integrated circuits (ASICs) counterparts, cannot handle as complex designs as ASICs, and tend to draw more power (for a given semiconductor process). Advantages include a shorter time to market, ability to re-program in the field to fix bugs, and lower non-recurring engineering costs. Based on the foregoing cost and performance considerations, FGPAs, PLDs and CPLDs are generally not suitable for consumer devices.

### SUMMARY

A device comprises an integrated circuit comprising N first circuit modules each having an enabled state, wherein N is an integer greater than zero and M second circuit modules each having a disabled state, wherein M is an integer greater than zero. A control module outputs upgrade data including identification of the M second circuit modules and allows selection and enablement of at least one of the M second circuit modules by a purchaser based on payment of at least a corresponding one of M prices associated with said M second circuit modules.

In other features, a display displays the upgrade data output by the control module and a user interface allows selection of the at least one of the M second circuit modules. The control module transmits identification data for at least one of the integrated circuit and the device via an external interface and receives the upgrade data via the external interface based on the identification data. The control module transmits at least one of selection and payment data via the external interface for the at least one of the M second circuit modules and receives module enabling data for the at least one of the M second circuit modules via the external interface.

In other features, the control module selectively enables the at least one of the M second circuit modules based on the module enabling data. The M second circuit modules are arranged on the integrated circuit at M distinct locations. The external interface communicates with a remote server, which is associated with one of a manufacturer of the integrated circuit, a manufacturer of the device and a retailer of the device.

In other features, the module enabling data is selected from a group consisting of a driver, a password and enabling code. The control module automatically generates the identification data without user input. The control module generates the identification data based on user input to the user interface. The external interface is integrated with the integrated circuit. The control module is integrated with the integrated circuit. At least one of the M second circuit modules is selected from a group consisting of a cellular third-generation (3G) transceiver module, a multiple in multiple out (MIMO) transceiver module, a global positioning system (GPS) module, a Bluetooth module, a wireless local area network (WLAN) module, and a frequency modulated (FM) tuner module.

A method comprises providing an integrated circuit within a device; enabling N first circuit modules of the integrated circuit, wherein N is an integer greater than zero; disabling M second circuit modules of the integrated circuit, wherein M is an integer greater than zero; providing upgrade data to an purchaser including identification of the M second circuit modules and M prices for enabling the M second circuit modules, respectively; and allowing selection and enablement of at least one of the M second circuit modules by the purchaser based on payment of at least a corresponding one of the M prices.

In other features, the method includes displaying the upgrade data on a display of the device; and selecting the at least one of the M second circuit modules to be enabled via a user interface of the device. The method includes providing an external interface; transmitting identification data for at least one of the integrated circuit and the device via the external interface; and receiving the upgrade data via the external interface based on the identification data.

In other features, the method includes providing an external interface; transmitting at least one of selection and payment data via the external interface for the at least one of the M second circuit modules; and receiving module enabling data for the at least one of the M second circuit modules via the external interface. The method includes selectively enabling the at least one of the M second circuit modules based on the module enabling data. The method includes arranging the M second circuit modules on the integrated circuit at M distinct locations.

In other features, the external interface communicates with a remote server, which is associated with one of a manufacturer of the integrated circuit, a manufacturer of the device and a retailer of the device. The method includes selecting the module enabling data from a group consisting of a driver, a password and enabling code. The method includes automatically generating the identification data without user input. The method includes generating the identification data based on user input to a user interface. The external interface is integrated with the integrated circuit. The method includes selecting at least one of the M second circuit modules from a group consisting of a cellular third-generation (3G) transceiver module, a multiple in multiple out (MIMO) transceiver module, a global positioning system (GPS) module, a Bluetooth module, a wireless local area network (WLAN) module, and a frequency modulated (FM) tuner module.

A method comprises incorporating an integrated circuit including (N+M) circuit modules into a device; enabling N of the circuit modules, wherein N is an integer greater than zero; disabling M of the circuit modules, wherein M is an integer greater than zero; establishing one or more pricing levels with respect to at least one of a device manufacturer, a retailer and an purchaser for the integrated circuit based on the N circuit modules that are enabled and the M circuit modules that are disabled; and configuring the integrated circuit to allow the purchaser to upgrade the device after purchasing the device by enabling at least one of the M circuit modules based on payment for the at least one of the M circuit modules.

In other features, the configuring the integrated circuit further comprises: configuring the integrated circuit to send identification data for at least one of the integrated circuit and the device, and receive upgrade description data for enabling the at least one of the M circuit modules based on the identification data. The configuring the integrated circuit further comprises configuring the integrated circuit to send at least one of upgrade selection and payment data, receive module enabling data based on the at least one of the upgrade selection and payment data, and enable the at least one of the M circuit modules based on the upgrade module enabling data.

In other features, the upgrade description data includes pricing data for enabling the at least one of the M disabled modules. The upgrade description data includes upgrade description data for the at least one of the M disabled modules. The module enabling data is selected from a group consisting of a driver, a password and enabling code. The method includes configuring the integrated circuit to automatically generate the identification data for the device without user input. The method includes configuring the integrated circuit to generate the identification data based on user input to the device. The method includes sharing upgrade revenue that is received by at least one of the retailer and the device manufacturer with the integrated circuit manufacturer.

In other features, the method includes selecting at least one of the M second circuit modules from a group consisting of a cellular third-generation (3G) transceiver module, a multiple in multiple out (MIMO) transceiver module, a global positioning system (GPS) module, a Bluetooth module, a wireless local area network (WLAN) module, and a frequency modulated (FM) tuner module. The method includes selling the integrated circuit to at least one of another device manufacturer and another retailer with S modules enabled and T modules disabled, where S and T are integers, S is not equal to N, T is not equal to M and wherein (S+T) is equal to (N+M).

A device comprises an integrated circuit comprising N first circuit means for providing N functions and each having an enabled state, wherein N is an integer greater than zero, and M second circuit means for providing M functions and each having a disabled state, wherein M is an integer greater than zero. Control means outputs upgrade data including identification of the M second circuit means and M prices for enabling the M second circuit means, respectively, and allows selection and enablement of at least one of the M second circuit means by an purchaser based on payment of at least a corresponding one of the M prices.

In other features, display means displays the upgrade data output by the control means. User interface means selects the at least one of the M second circuit means. External interface means provides an external interface to the device. The control means transmits identification data for at least one of the integrated circuit and the device via the external interface and receives the upgrade data based on the identification data. The control means transmits at least one of selection and payment data via the external interface means for the at least one of the M second circuit means and receives enabling data for the at least one of the M second circuit means via the external interface means.

In other features, the control means selectively enables the at least one of the M second circuit means based on the enabling data. The M second circuit means are arranged on the integrated circuit at M distinct locations. The external interface communicates with a remote server, which is associated with one of a manufacturer of the integrated circuit, a manufacturer of the device and a retailer of the device. The enabling data is selected from a group consisting of a driver, a password and enabling code. The control means automatically generates the identification data without user input. User interface means provides a user interface.

In other features, the control means generates the identification data based on user input to the user interface means. The external interface means is integrated with the integrated circuit. The control means is integrated with the integrated circuit. At least one of the M second circuit means is selected from a group consisting of a cellular third-generation (3G) transceiver means, a multiple in multiple out (MIMO) transceiver means, a global positioning system (GPS) means, a Bluetooth means, a wireless local area network (WLAN) means, and a frequency modulated (FM) tuner means.

A device comprises a first circuit module that is initially disabled when the device is delivered to a purchaser and that includes an activation module that is adapted to selectively enable the first circuit module after the delivery. A control module controls operation of at least one function of the device, executes at least one first application that is enabled, and executes at least one of T second applications that require enablement of the first circuit module, where T is an integer greater than zero. The control module comprises an activation managing module that communicates with the activation module to activate the first circuit module based on enable data and identification (ID) data associated with the device.

In other features, the activation managing module recovers a key from the enable data and transmits the key to the activation module to enable the first circuit module and to allow execution of the T second applications. The first circuit module is implemented by a first integrated circuit and the control module is implemented by a second integrated circuit. The first circuit module and the control module are implemented by a first integrated circuit. The first circuit module performs a network-related function. The first circuit module comprises a wireless network interface.

In other features, when an attempt to launch at least one of the T second applications is made before the first circuit module is enabled, the control module outputs a message with instructions for enabling the first circuit module. The activation managing module further comprises a time limiting module that limits use of the first circuit module to a predetermined period after enablement of the first circuit module. The activation managing module further comprises a usage limiting module that limits usage of the first circuit module to at least one of a predetermined number of sessions after enablement of the first circuit module and a predetermined amount of data exchanged after enablement of the first circuit module. The activation managing module limits use of the first circuit module to S of the T second applications, where S is an integer less than T. The enable data comprises the key that is hashed with the ID data. The enable data comprises the ID data and usage limiting data that are hashed with the key. The enable data is received after the purchaser pays a price associated with use of the first circuit module.

In other features, a display displays purchaser upgrade selections that are output by the control module. A user interface selects at least one of the purchaser upgrade selections. An external interface communicates data between the control module and a remote server to upgrade the device. The remote server is associated with one of a manufacturer of the integrated circuit, a manufacturer of the device and a retailer of the device.

A camera comprises the device and further comprises an image processing module that processes image data. The first circuit module comprises a wireless network interface. The price further includes payment for data services associated with a wireless network. The enable data is transmitted one of in band and out of band on a wireless network. The first circuit module wirelessly receives the enable data.

A method comprises incorporating a first circuit module that is initially disabled into a device; configuring the first circuit module to be selectively enabled after delivery to a purchaser; loading at least one first application on the device that is enabled; loading T second applications on the device that require enablement of the first circuit module after delivery to the purchaser, where T is an integer greater than zero; and configuring the device to enable the first circuit module based on enable data and identification (ID) data associated with the device.

In other features, the method includes recovering a key from the enable data based on the ID data; and using the key to enable used of the first circuit module and to execute the T second applications. The method includes implementing the first circuit module using a first integrated circuit; and performing at least one of the receiving, recovering and selectively enabling using a second integrated circuit that communicates with the first integrated circuit. The method includes implementing the first circuit module using a first integrated circuit; and performing at least one of the receiving, recovering and selectively enabling using the first integrated circuit.

In other features, the method includes configuring the first control module to perform a network-related function. The method includes configuring the first control module to provide a wireless network interface. The method includes configuring the device to display a message with instructions for enabling the first circuit module when at least one of the T second applications is selected before the first circuit module is enabled. The method includes configuring the device to limit use of the first circuit module to a predetermined period after enablement. The method includes configuring the device to limit usage of the first circuit module to at least one of a predetermined number of sessions after enablement and a predetermined amount of data exchanged after enablement. The method includes configuring the device to limit use of the first circuit module to S of the T second applications, where S is an integer less than T.

In other features, the method includes hashing the key with the ID data to generate the enable data. The method includes hashing the key with the ID data and usage limiting data to generate the enable data. The method includes configuring the device to receive the enable data after the purchaser pays a price associated with use of the first circuit module. The method includes configuring the device to: display upgrade selections; and allow selection of at least one of the upgrade selections. The method includes configuring the device to exchange data between the device and a remote server using an external interface to upgrade the device. The remote server is associated with one of a manufacturer of the integrated circuit, a manufacturer of the device and a retailer of the device.

In other features, the method includes configuring the device to provide a wireless network interface; and including payment for wireless data services associated with a wireless network in the price. The method includes configuring the device to receive the enable data one of in band and out of band on a wireless network.

A device comprises first circuit means for performing a predetermined function, that is initially disabled when the device is delivered to a purchaser and that includes activation means for selectively enabling the first circuit means after the delivery. Control means controls operation of at least one function of the device, executes at least one first application that is enabled, and executes at least one of T second applications that require enablement of the first circuit means, where T is an integer greater than zero. The control means comprises activation managing means that communicates with the activation means to activate the first circuit means based on enable data and identification (ID) data associated with the device.

In other features, the activation managing means recovers a key from the enable data and transmits the key to the activation means to enable the first circuit means and to allow execution of the T second applications. The first circuit means is implemented by a first integrated circuit and the control means is implemented by a second integrated circuit. The first circuit means and the control means are implemented by a first integrated circuit. The first circuit means performs a network-related function. The first circuit means comprises a wireless network interface.

In other features, when an attempt to launch at least one of the T second applications is made before the first circuit means is enabled, the control means outputs a message with instructions for enabling the first circuit means. The activation managing means further comprises time limiting means that limits use of the first circuit means to a predetermined period after enablement of the first circuit means. The activation managing means further comprises usage limiting means that limits usage of the first circuit means to at least one of a predetermined number of sessions after enablement of the first circuit means and a predetermined amount of data exchanged after enablement of the first circuit means. The activation managing means limits use of the first circuit means to S of the T second applications, where S is an integer less than T. The enable data comprises the key that is hashed with the ID data. The enable data comprises the ID data and usage limiting data that are hashed with the key. The enable data is received after the purchaser pays a price associated with use of the first circuit means.

In other features, display means displays purchaser upgrade selections that are output by the control means. User interface means selects at least one of the purchaser upgrade selections. External interface means communicates data between the control means and a remote server to upgrade the device. The remote server is associated with one of a manufacturer of the integrated circuit, a manufacturer of the device and a retailer of the device.

A camera comprises the device and further comprises image processing means for processing image data. The first circuit means comprises a wireless network interface. The price further includes payment for data services associated with a wireless network. The enable data is transmitted one of in band and out of band on a wireless network and wherein the first circuit means wirelessly receives the enable data.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a device including an IC, SOC or SIP with one or more enabled modules and one or more disabled modules that can be remotely enabled after purchase according to the present disclosure;

FIGS. 2A-2C illustrate exemplary ways for enabling previously disabled modules according to the present disclosure;

FIG. 3 is a functional block diagram of an exemplary cellular phone with one or more initially disabled circuit modules that can be enabled by an purchaser after purchase according to the present disclosure;

FIG. 4 illustrates an exemplary method for selling the devices of FIGS. 1-3 according to the present disclosure;

FIG. 5 is a functional block diagram of a device according to another exemplary implementation of the present disclosure;

FIG. 6 illustrates a method for enabling a circuit module of the device of FIG. 5 according to the present disclosure;

FIG. 7 is a functional block diagram of exemplary camera including an initially disabled, wireless network circuit module that provides a wireless network interface according to the present disclosure;

FIG. 8 illustrates a method for controlling the use of an initially disabled circuit module in the device of FIG. 5 after enablement according to the present disclosure;

FIG. 9 illustrates a method for distributing the device of FIG. 5 and enabling the circuit module after the sale according to the present disclosure;

FIG. 10 illustrates a method for generating enable data according to the present disclosure according to the present disclosure;

FIG. 11A is a functional block diagram of a high definition television according to the present disclosure;

FIG. 11B is a functional block diagram of a vehicle control system according to the present disclosure;

FIG. 11C is a functional block diagram of a set top box according to the present disclosure; and

FIG. 11D is a functional block diagram of a mobile device according to the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

As used herein, the term circuit module may be used to refer to a combination of electronic circuits having a predetermined function that is established during semiconductor fabrication—in contrast with FPGAs, PLDs and CPLDs that have their functions determined after fabrication using special programming. In addition, the circuit module may optionally include software or firmware programs that are run on a processor associated with the circuit module and/or by a processor that is external to the circuit module and that is shared with other components of the device. The predetermined functions may include functions that otherwise cannot be performed by a general purpose processor of the device with software upgrades.

A logic structure of the circuit modules may also be configured and fixed during semiconductor fabrication. Therefore, the term circuit module as used herein generally excludes the use of FPGAs, PLDs and CPLDs (unless used in addition to the circuit modules described above) since their logic structures are altered after fabrication. FPGAs, PLDs and CPLDs may also not be suitable for consumer applications described herein due to their cost, power consumption, and/or processing speed. Furthermore, FPGAs, PLDs and CPLDs are not suitable for implementing the predetermined functions of the circuit modules described herein since the intended functions of the circuit modules are known in advance, which is contrary to the reasons for using FPGAs, PLDs and CPLDs in the first place.

For example only, one circuit module may provide a wireless network interface with application specific circuits that are configured to provide a physical layer (PHY) device and a medium access control (MAC) device. The wireless network interface may rely on a local processor or may share a processor with other components of the device. Other examples are presented below. The term circuit module is being used to describe a subset of the larger term modules that may include components that are software-based programs that run on processors and that rely on existing enabled circuits of the device.

The present disclosure relates to devices and methods for manufacturing an IC, SOC or SIP with both enabled and disabled circuit modules. One or more of the circuit modules are enabled when sold by the IC, SOC or SIP manufacturer (hereinafter, “IC supplier”) to a device manufacturer or a retailer. In other words, the device manufacturer or a retailer may select the circuit modules that are to be enabled. The parties negotiate a suitable price based on the enabled circuit modules. Later one or more of the disabled circuit modules can be selectively enabled by the purchaser as will be described below. Drivers, enabling codes or passwords, enable gates or registers, or receive other data or code are requested and received after the sale by the purchaser or the device to enable a previously disabled circuit module.

After incorporating the IC, SOC or SIP in the device, the device manufacturer may sell the device directly to the purchaser or to a retailer who sells the device to the purchaser. The purchaser has full use of the enabled circuit modules of the IC, SOC or SIP in the device. The IC supplier (or the device manufacturer or the retailer) may let the purchaser know that the device can be upgraded. In other words, the purchaser may receive information about disabled circuit modules in the device.

After the sale, the purchaser may want to enable one or more of the disabled circuit modules in the device. The purchaser may purchase one or more of the previously disabled circuit modules from the IC supplier, the device manufacturer and/or the retailer as will be described below. In some implementations, data services may also be sold (for example only, when the enabled circuit module provides a wireless network interface). Furthermore, revenue sharing can occur with the IC supplier when the purchaser upgrades indirectly via the retailer or device manufacturer.

For example only, one cellular phone manufacturer may want a low cost IC, SOC or SIP with a basic feature set (of enabled circuit modules). Another cellular phone manufacturer may want the basic feature set and an integrated FM tuner circuit module. Another cellular manufacturer may want the basic feature set and an integrated Bluetooth transceiver circuit module. Still another manufacturer may want the basic feature set and an integrated WiFi and/or WiMax network interface circuit module. Another manufacturer may want the basic feature set and an integrated global positioning system (GPS) circuit module. Another manufacturer may want the basic feature set and all of the additional features mentioned above. The IC supplier can negotiate different pricing levels for each of these customers.

After purchasing the device, the purchaser may want to add additional features that were not initially selected and purchased by the device manufacturer or the retailer. The purchaser can contact the IC supplier, device manufacturer and/or retailer who can identify available upgrade options for the device. Alternately, the IC supplier, the device manufacturer or the retailer may initiate contact with the purchaser. If the purchaser selects one of the upgrades, the purchaser may need to provide a device ID (either manually or automatically) (such as a Serial Number of the IC, SOC or SIP or the device) and payment before the circuit module is enabled. If the IC supplier, device manufacturer and/or retailer sells the additional features, they will receive incremental revenue that is mostly profit.

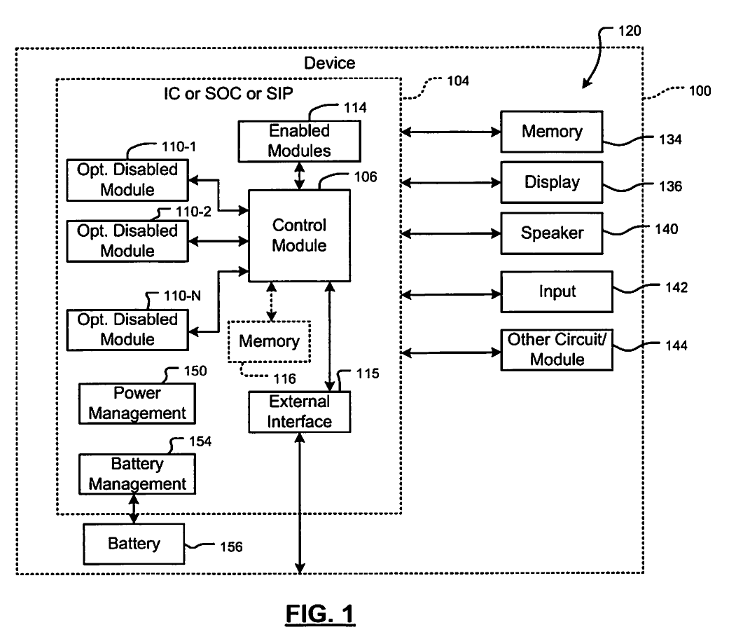

Referring now to FIG. 1, a device 100 may include an IC, SOC or SIP 104. The IC, SOC or SIP 104 may include a control module 106, and one or more circuit modules 110-1, 110-2, . . . and 110-N that may be selectively enabled or disabled. The circuit modules 110-1 . . . 110-N may each have a predefined function. The IC, SOC or SIP 104 may include a basic feature set including one or more enabled circuit modules 114 that perform the basic feature set. The IC, SOC or SIP may include an external interface 115 such as a serial port, a cellular transceiver, a parallel port, a wired or wireless network interface, a transceiver or any other suitable interface. The IC, SOC or SIP 104 many include semiconductor memory 116.

The device 100 may also include other components 120 that may or may not be implemented by the IC, SOC or SIP 104. For example only, the other components 120 may include volatile or nonvolatile memory 134, a display 136, a speaker 140, a user input 142 such as a keypad or touchpad, and/or other modules generally identified at 144.

The IC, SOC or SIP 104 may also implement a power management module 150 and a battery management module 154. The battery management module 154 may control charging and monitoring of a battery 156. The power management module 150 may provide one or more supply voltages to other components of the device 100. The power management module 150 may conserve power by setting the one or more circuit modules 110-1 . . . 110-N to a low power consumption level or mode when they are disabled. The power management module 150 and/or battery management module 154 may be implemented separately from the IC, SOC or SIP 104. The control module 106 and the external interface 115 may be implemented separately from the IC, SOC or SIP 104.

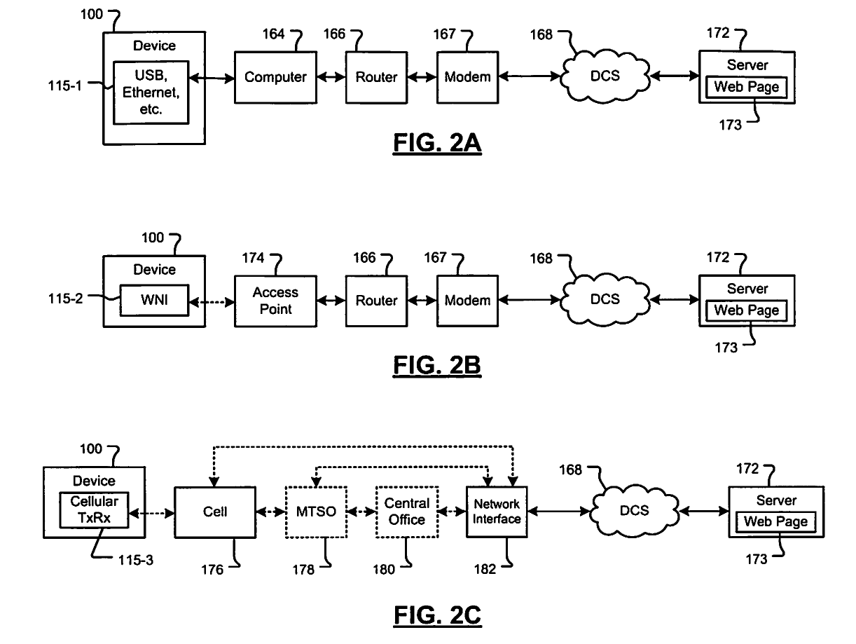

Referring now to FIGS. 2A-2C, exemplary implementations for enabling initially disabled circuit modules 110 in the IC, SOC or SIP 104 associated with the device 100 are shown. For example only, in FIG. 2A the external interface 115 of the device 100 includes a Universal Serial Bus (USB) or network interface 115-1 that transmits data to and/or receives data from a computer 164. While a USB or network interface 115-1 is shown, any other interface may be used. The network interface may comprise an Ethernet interface. The computer 164 communicates with a router 166 and a modem 167 such as a broadband modem. The modem 167 transmits and receives data packets via a distributed communications system (DCS) 168, such as the Internet, to a server 172. The server 172 may provide a web page 173 or other interface that provides a user interface for enabling previously disabled circuit modules 110 in the IC, SOC or SIP 104 associated with the device 100, as will be described further below.

In this exemplary implementation, a browser of the computer 164 is used to access the web page 173 and forwards purchaser information to the server 172. The web page 173 may also request an ID or serial number from the IC, SOC or SIP 104. The purchaser information may be automatically generated when the device 100 is connected to the computer 164. Alternately the purchaser may enter the information via the user input 142.

The web page 173 may initiate a dialog with the purchaser and provide a list of disabled circuit modules 110 in the IC, SOC or SIP 104 that the user may select and enable, along with descriptions of the circuit modules and/or pricing information. Once the selections are made, the purchaser may input payment for the selected items. Once payment is confirmed, the web page 173 may initiate download of driver software, enabling code, passwords or other data or code that can be used to enable the previously disabled circuit modules 110. Encryption and decryption using keys may also be used. Hashing or other techniques may also be used.

Instead of (or in addition to) using the USB or network interface 115-1 and the computer 164 in FIG. 2A, the device 100 may provide an interface that can be used to directly interface with the web page 173 on the server 172. For example only in FIG. 2B, the external interface 115 of the device 100 may include a wireless network interface (WNI) 115-2 that wirelessly transmits data to and/or receives data from an access point (AP) 174. The AP 174 communicates with the router 166 and the modem 167. The modem 167 transmits and receives data packets via the DCS 168 between the server 172 and the device 100. The server 172 may provide the web page 173 for enabling previously disabled circuit modules 110 in the IC, SOC or SIP 104 associated with the device 100 as described above and below.

In this exemplary implementation, the control module and operating system of the device 100 are used to access the web page 173 and forward purchaser information to the server 172. The purchaser information may be automatically generated by the device 100. Alternatively the purchaser may enter the information using the user input 142 of the device 100. The web page 173 may initiate a dialog with the purchaser and provide a list of disabled circuit modules 110 in the IC, SOC or SIP 104 that the user may select and enable, along with descriptions of the circuit modules and/or pricing. Once the selections are made, the user may input a payment method for the selected items. Once payment is confirmed, the web page 173 may initiate download of driver software, enabling code, passwords or other information that can be used by the device 100 to enable the previously disabled circuit modules 110.

Instead of (or in addition to) using the WLAN interface 115-2, a cellular transceiver may be used to interface with the web page 173 on the server 172. For example only in FIG. 2C, the external interface of the device 100 includes a cellular transceiver 115-3 that wirelessly transmits data to and/or receives data from a cell 176. The cell 176 communicates with a mobile telephone switching office (MTSO), which communicates with a central office 180. The central office 180 may provide a connection to the DCS 168 via a network interface 182. Alternately, the cell 176 or MTSO 178 may provide a direct connection to the network interface 182. The server 172 may provide the web page 173 for enabling previously disabled circuit modules 110 in the IC, SOC or SIP 104 associated with the device 100.

In this exemplary implementation, the control module and operating system of the device 100 are used to access the web page 173 and forward purchaser information to the server 172 via the cellular network. The purchaser information may be automatically generated by the device 100. Alternately the purchaser may enter the information using the user input 142 of the device 100. The web page 173 may initiate a dialog with the purchaser, provide a list of disabled circuit modules 110 in the IC, SOC or SIP 104 that the user may select and enable and pricing. Once the selections are made, the purchaser may input a payment method for the selected items. Alternately, the purchaser may be automatically charged through the corresponding cellular account. Once payment is confirmed, the web page 173 may initiate download of driver software, enabling code, passwords or other code or data that can be used by the device 100 to enable the previously disabled circuit modules 110 as described herein.

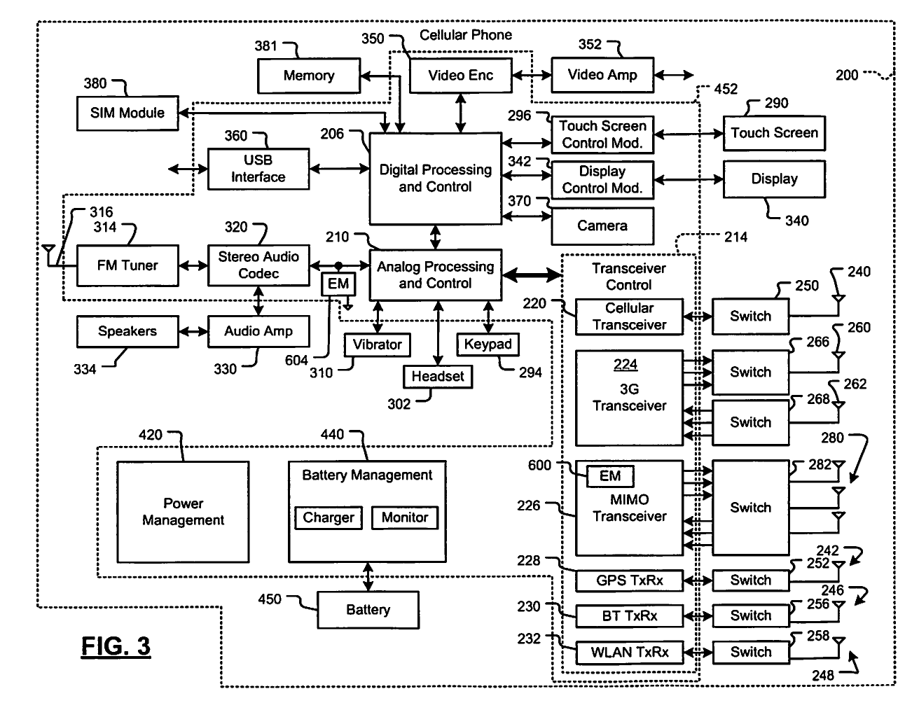

Referring now to FIG. 3, an exemplary cellular phone 200 is shown. The cellular phone 200 includes digital processing and control module 206, an analog processing and control module 210, and a transceiver control module 214. The digital processing and control module 206 performs processing and control of digital signals. The analog processing and control module 210 performs processing and control of analog signals such as baseband signals. The transceiver control module 214 transmits and receives baseband signals from the analog processing and control module 210 and includes two or more transceivers. The transceiver control module 214 also transmits and receives RF signals via antennas.

The transceiver control module 214 may include a cellular transceiver circuit module 220, a cellular third-generation (3G) (or Global System for Mobile communications (GSM)) transceiver circuit module 224, a multiple in multiple out (MIMO) transceiver circuit module 226, a global positioning system (GPS) circuit module 228, a Bluetooth transceiver circuit module 230, a WLAN transceiver circuit module 232 and/or other transceiver circuit modules. The cellular, GPS, Bluetooth and WLAN transceiver circuit modules 220, 228, 230 and 232 selectively communicate with antennas 240, 242, 246 and 248 via switches 250, 252, 256 and 258, respectively. The 3G transceiver circuit module 224 selectively communicates with antennas 260 and 262 via switches 266 and 268, respectively. The MIMO transceiver circuit module 226 communicates with an array of antennas 280 via a switch 282.

As can be appreciated, the wireless network interfaces disclosed herein may be compliant with one or more of the following IEEE standards 802.11, 802.11a, 802.11b, 802.11g, 802.11h, 802.11n, 802.16, and 802.20.

A cellular user may input information into the cellular phone 200 using a touch screen 290 and/or a keypad 294. The touch screen 290 allows a user to input information using a display 340. The touch screen 290 communicates with a touch screen control module 296, which interprets the inputs and communicates with the digital processing and control module 206. The keypad 294 allows a user to input alphanumeric information to the analog processing and control module 210.

A user headset 302, which may include a speaker and a microphone (both not shown), may receive voice signals from the user and output audio signals to the user. A vibrator 310 may be used to vibrate the cellular phone 200 to silently alert the user that an incoming call or message was received. The vibrator 310 may be controlled by the analog processing and control module 210.

The cellular phone 200 may include an FM tuner circuit module 314 that can be used to select FM stations. The FM tuner circuit module 314 receives FM signals via an antenna 316 and outputs FM signals to a stereo/audio coder/decoder circuit module 320. The coder/decoder circuit module 320 receives control signals from the analog processing and control module 210 and outputs decoded audio signals to an audio amplifier 330 and speakers 334. The speakers 334 may optionally be internal to the cellular phone 200 and/or a jack may be provided for external speakers.

The display 340 communicates with a display control module 342, which receives display signals from the digital processing and control module 206. The cellular phone 200 also may include a video encoder circuit module 350 that encodes video signals. An output of the video encoder circuit module 350 is input to a video amplifier 352. The video encoder circuit module 350 may perform any suitable video encoding. For example only, the video encoder may perform NTSC, PAL and SECAM encoding. The video encoder circuit module 350 may also perform 3-D encoding.

The cellular phone 200 also may include a serial interface such as a Universal Serial Bus (USB) interface 360, a parallel interface, or any other suitable interface that allows connection to a computer. The cellular phone 200 also may include a camera circuit module 370, which may include a charge coupled device (CCD) sensor. A removable simulation circuit module 380 may be provided to configure the cellular phone 200 for a particular geographic region and/or cellular protocol. Additional volatile or nonvolatile memory 381 may be provided.

The cellular phone 200 may also include a power management module 420 and a battery management module 440. The battery management module may control charging and monitoring of a battery 450. The power management module 420 may provide one or more supply voltages to other components of the cellular phone 200.

One or more circuit modules of the cellular phone described above may be implemented by an IC, SOC or SIP 452. More particularly, the IC, SOC or SIP 452 implements circuit modules of the basic feature set which are enabled. The IC, SOC or SIP 452 may also implement one or more circuit modules that are disabled at the time of sale to the purchaser.

The IC, SOC or SIP 452 may be sold by the IC supplier to a device manufacturer, retailer or purchaser with the basic feature set enabled. Some of the circuit modules will be included in the basic feature set. Others of the circuit modules will not be enabled when sold to the device manufacturer, retailer or purchaser. As can be appreciated, this will allow the device manufacturer to purchase the IC, SOC or SIP at a desired price point from the IC supplier. Furthermore, the IC supplier can use the same die to build ICs or SOCs for multiple different device manufacturers (retailers or purchasers) and applications and at different price points.

Under normal circumstances, the revenue stream to the IC supplier ends when the IC supplier sells the IC, SOC or SIP to the device manufacturer. However, the IC supplier (or manufacturer or retailer) may enable other circuit modules in the IC, SOC or SIP after retail sale and generate additional revenue. For example, the IC supplier, device manufacturer or retailer may charge an additional amount for each circuit module that is enabled. For example only, the IC supplier, manufacturer or retailer may charge less than $15 for enabling a circuit module. For example only, the IC supplier, device manufacturer or retailer may charge less than $10 for enabling a circuit module. For example only, the IC supplier, device manufacturer or retailer may charge less than $5 for enabling a circuit module. For example only, the IC supplier, device manufacturer or retailer may charge less than $1 for enabling a circuit module. As can be appreciated, the incremental charge for enabling the circuit module will be mostly incremental profit.

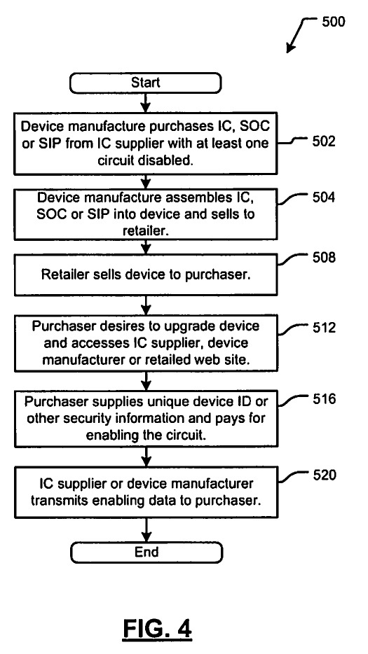

Referring now to FIG. 4, a business method 500 according to the present disclosure is shown. In step 502, a device manufacturer purchases or otherwise procures the IC, SOC or SIP from the IC supplier with enabled circuit modules and at least one disabled circuit module. In step 504, the device manufacture assembles the IC, SOC or SIP into the device and sells or provides the device to a retailer. In step 508, the retailer sells or provides the device to a purchaser. It should be understood that the device may be provided to the purchaser by the retailer or any other party via a sale or other methods. For example, a device may be given to the purchaser on a free-of-charge promotional basis.

In step 512, the purchaser desires to upgrade the device and contacts the IC supplier, the retailer or the device manufacturer. For example, the purchaser may access a web site of the retailer, the IC supplier or the device manufacture as described above. Alternately, contact may be initiated by the IC supplier, retailer or device manufacturer to inform the purchaser that the device may be upgraded. In step 516, the purchaser optionally supplies a unique ID associated with the device or other security information and pays for enabling a previously disabled circuit module. In step 520, the retailer, the IC supplier or the device manufacturer downloads a driver, key, password or other enabling code or data to the purchaser (as described herein) after confirming payment. In step 524, the device enables the previously-disabled circuit module. It should be understood that, in some situations, the purchaser may upgrade the device by specifying the additional service(s) or feature(s) that s/he desires. The retailer, the IC supplier or the device manufacturer may then enable the appropriate circuit module(s) to allow such additional service(s) or feature(s) to be effected on the device. In such situations, the enabling of appropriate circuit module(s) is transparent to the purchaser.

For example, referring back to FIG. 3, the basic feature set may include the cellular transceiver circuit module 220, the USB interface 360, the display control module 342 and the display 340, the power and battery management modules 420 and 440, the digital and analog processing and control modules 206 and 210, the vibrator 310, the headset 302 and the keypad 294. The remaining circuit modules may be initially disabled and may be selectively enabled after sale to the purchaser as described above. In other examples, circuit modules may be selectively enabled to subsequently implement services and/or features, such as, higher performance processors with higher or different speeds and/or processing power, higher performance web browsers, higher data rates, higher bandwidth or throughput, etc. Still other combinations of enabled and disabled circuit modules are contemplated.

There are a variety of ways to selectively disable/enable the circuit modules. For example only, each of the selectively enabled circuit modules may include a local enabling module (EM) (for example only, as shown at 600 in the MIMO transceiver circuit module 226 in FIG. 3) arranged in the corresponding module. The enabling module 600 may require a password, key or other enabling code to be received to enable the circuit module. Alternately, the enabling circuit 600 may require a register or gate to be set to a particular value. Encryption/decryption and/or hashing can be used as well.

Alternately, another type of enabling circuit 604 may be used to pull signals to/from the sub-circuit or circuit module (such as to the FM tuner circuit module 314) to a reference potential (such as ground) to disable and open the connection to enable the circuit module. In another alternate implementation, a driver is installed in one or both of the digital and analog processing and control modules 206 and 210 to enable the circuit module. Alternately, at least one of the digital and analog processing and control modules 206 and 210 may include a register or gate that can be set to a particular value to enable the circuit module. In other implementation, the power management module may selectively provide power to enabled circuit modules and cut off power to disabled circuit modules. Drivers may be provided to enable the circuit modules. Still other methods of enabling and disabling the circuit modules may be used.

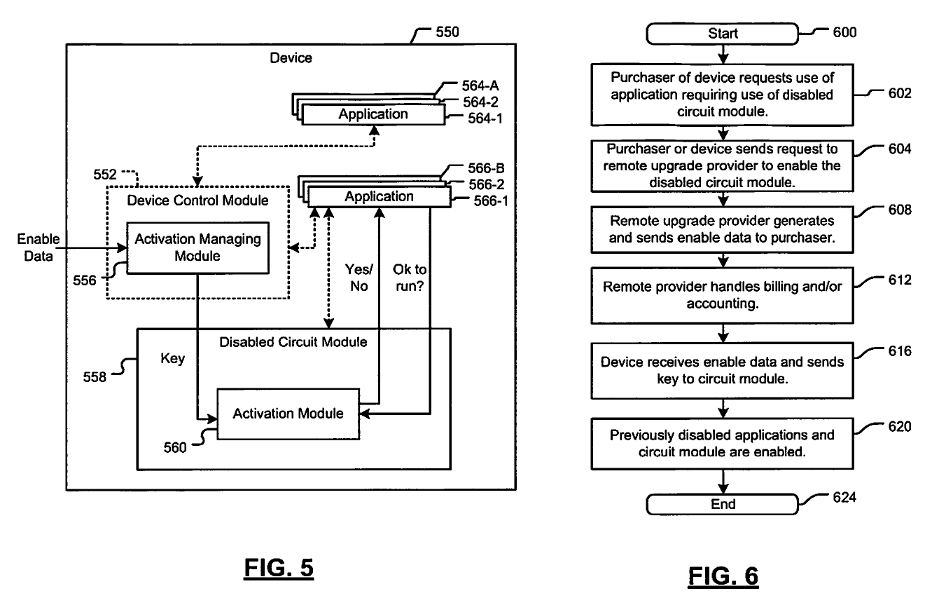

Referring now to FIG. 5, a device 550 according to another exemplary implementation of the present disclosure is shown. The device 550 includes a device control module 552 including an activation managing module 556. The device 550 further includes an initially disabled circuit module 558 that can be selectively enabled based on enable data. The disabled circuit module 558 includes an activation module 560 that communicates with the activation managing module 556.

The device 550 includes first applications by 564-1, 564-2, . . . , and 564-A (collectively first applications 564) that are enabled when the device is sold. The device 550 further includes one or more second applications 566-1, 566-2, and 566-B (collectively second applications 566) that are fully or partially disabled when the device is sold because they require enablement of the circuit module 558. The second applications 566 are executed by the circuit module 558 after the previously disabled circuit module 558 is enabled using the enable data. If the purchaser attempts to launch one of the second applications 564 before the disabled circuit module 558 is enabled, a message may be generated stating that the second application 566 requires enablement of the disabled circuit module 558. An instruction message may be provided for enabling the disabled circuit module 558. For example, a website may be identified in the message, a phone number or other information may be provided.

In use, the purchaser may launch one of the applications 566 that requires the disabled circuit module 558. The application 566 sends a message to the circuit module 558 to determine whether or not it is enabled. The activation module 560 responds that it is not enabled since the disabled circuit module 558 still requires enablement.

The purchaser may then initiate enablement of the disabled circuit module as described herein. In response to the request, enable data is received by the activation managing module 556. The enable data may be encrypted using any suitable approach. The enable data may include authorization data, such as, payment confirmation, device purchase confirmation and/or other types of information that may be used to indicate that enablement of the disabled circuit module is permitted. For example, the enable data may be encrypted by hashing using a device specific identification (ID). The device specific ID may comprise a serial number (SN) of the device, a medium access control (MAC) address, etc. Alternatively, the enable data may be created by hashing of shared secret key or by signature using public/private key cryptography.

When enable data is received and hashing is used, the activation managing module 556 may hash the received enable data with the device-specific ID to recover a secret key and/or other data such as usage limiting data. The usage-limiting data may include application-specific limits, time limits or other usage limits. Any suitable hash algorithm may be used such as for example only, MD5 and Secure Hash Algorithms (SHA) may be used.

Referring now to FIG. 6, a method for upgrading the device of FIG. 5 is shown. Control begins with step 600. In step 602, a purchaser of the device 550 requests use of a disabled application 566. In step 604, the purchaser or the device 550 sends a request to a remote upgrade provider. The remote upgrade provider may be the retailer, the IC supplier or the device manufacturer. The purchaser may use the device 550 to send the message. For example, the disabled circuit module may be partially enabled to allow this function. For example only, if the disabled circuit module is a wireless network interface, it may be partially enabled when sold such that it can handle wireless transactions relating to the request for enablement and/or the receipt of the enable data but not other more general use. Alternately, other interfaces of the device may be used. For example, the request may be made via a USB interface, another receiver of the device, etc.

Alternately, the request for enablement may be sent in other ways (not using the device). In other words, the purchaser may send a message via a browser of another computing device to a web page of the IC supplier, device manufacturer or retailer. Alternately, the purchaser may use a phone to contact the IC supplier, device manufacturer or retailer to request activation. The purchaser may also receive and enter the enable data into the device manually. Still other methods of requesting enablement of the disabled circuit module may be used.

In step 608, the remote upgrade provider generates and sends enable data to the purchaser. The enable data may be encrypted and may be specific to the particular requesting device. In step 612, the remote provider handles billing the purchaser for the enablement of the disabled circuit module 558. In some implementations, data services may also be enabled (for example only, for wireless network services). In step 616, the device receives the encrypted enable data and sends the key to the circuit module. In step 620, the device is allowed to use the previously disabled applications and circuit module 558.

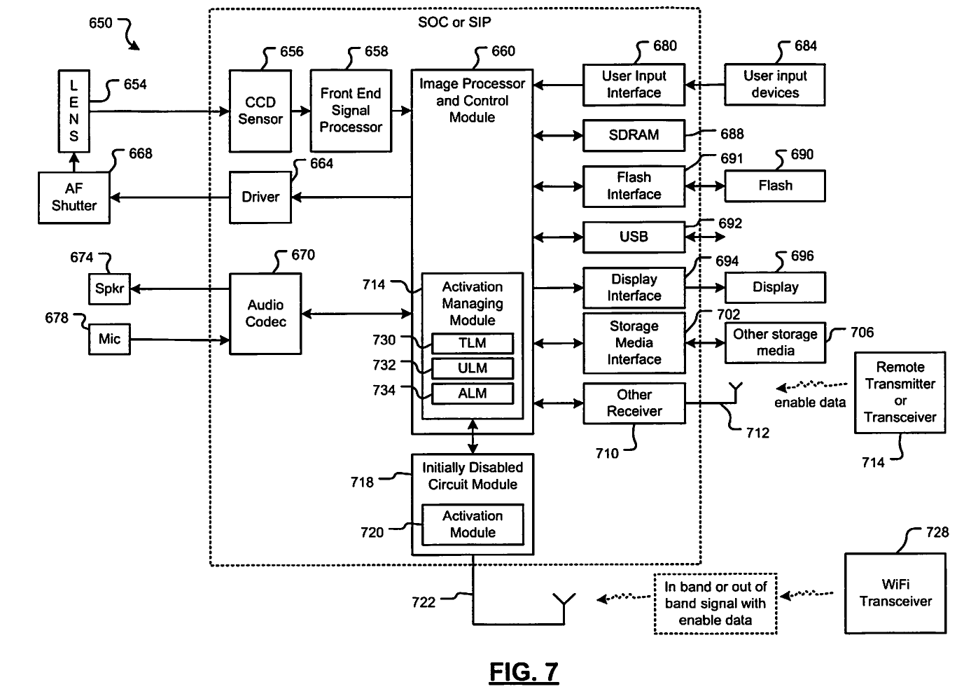

Referring now to FIG. 7, an exemplary camera including an initially disabled circuit module 718 that provides a wireless network interface according to the present disclosure is shown. Skilled artisans will appreciate that while a specific functional block diagram is shown, the camera may have other implementations.

The camera 650 includes a lens 654. The lens 654 focuses light on a charge coupled device (CCD) sensor 656. A front end signal processor 658 receives an output of the CCD sensor 656. An image processor and control module 660 receives an output of the front end signal processor 658. The image processor and control module 660 may include a driver 664 that operates an autofocus (AF) and shutter 668.

The image processor and control module 660 communicates with an audio coder/decoder (CODEC) 670, which provides audio output signals to a speaker 674 and receives audio signals from a microphone 678. The image processor and control module 660 also communicates with a user input interface 680 that receives outputs of user input devices 684. The user input device 684 may comprise as a keypad, control buttons, etc. that are used to control the camera 650.

The camera 650 may also comprise high-speed memory 668 such as SDRAM for storing data and/or code during processing. The camera 650 may also include flash memory 690 that communicates with the image processor and control module 660 via a flash memory interface 691. The flash memory 690 may be used to store content such as video, audio and/or still pictures. The camera 650 may also comprise a Universal Serial Bus (USB) interface 692.

A display interface 694 provides an interface for a display 696. In some implementations, the display 696 may include a touch screen. A storage media interface 702 provides an interface between other types of storage media 706 and the image processor and control module 660. For example, the storage medium interface may comprise a serial digital (SD) interface for SD memory. The camera 650 may include a wireless receiver 710 with an antenna 712 that receives wireless signals from a remote transmitter or transceiver 714.

The image processor and control module 660 includes an activation managing module 714 that manages enablement of the disabled circuit module. The camera 650 may comprise a circuit module 718 that is initially disabled. For example only, the circuit module may provide a wireless network interface that is initially disabled. However, the circuit module 718 may have other functions. The circuit module 718 includes an activation module 720.

The circuit module 718 may comprise a physical layer (PHY) module (not shown) that provides an interface to a medium and a medium access control (MAC) module (not shown) that provides an interface between the physical layer module and a host. The MAC module may have a MAC number that can be used as a unique ID. Alternately, the device or one or more ICs may have a serial number that can be used as the unique ID. In other implementations, the unique ID may be a number stored in silicon that is inaccessible to users.

The circuit module 718 may communicate with an antenna 722. In some implementations, a network transceiver 728 (such as an access point) transmits in-band or out-of-band signals including encrypted enable data. The circuit module 718 receives the encrypted enable data. The circuit module 718 may operate in a restricted feature mode that allows reception of the in-band or out-of-band enable data but is otherwise not operational. Alternately, the remote transmitter or transceiver 714 transmits enable data to the receiver 710.

The activation managing module 714 may comprise a time limiting module (TLM) 730 that selectively limits the amount of time that the disabled circuit module is enabled. For example, the circuit module 718 may be enabled for a day, week, month or other period. The activation managing module 714 may comprise a usage limiting module (ULM) 732 that selectively limits usage. For example, the circuit module may be enabled for a predetermined amount of data exchanged or a predetermined number of sessions.

The activation managing module 714 may comprise an application limiting module (ALM) 734 that selectively limits the second applications that the disabled circuit module can use. For example, the circuit module 718 may be enabled for one or some of the second applications but not others of the second applications. Alternately, all of the second applications can be enabled.

As can be appreciated, one or more of the TLM 730, the ULM 732 and the ALM 734 may be implemented by the activation module 720. Alternately, both the activation managing module 714 and the activation module 720 may be combined into a single activation module that is implemented by one circuit module (such as the circuit module 718) or by a device control module (such as the image processor and control module 660).

As can be appreciated, the circuit module 718 may be implemented as a first integrated circuit and other components of the camera 650 (such as the image processor and control module 660 and/or other components) may be implemented as a second integrated circuit. Alternately, the circuit module 718 and the image processor and control module 660 and/or other components of the camera may be implemented as a SOC or a SIP.

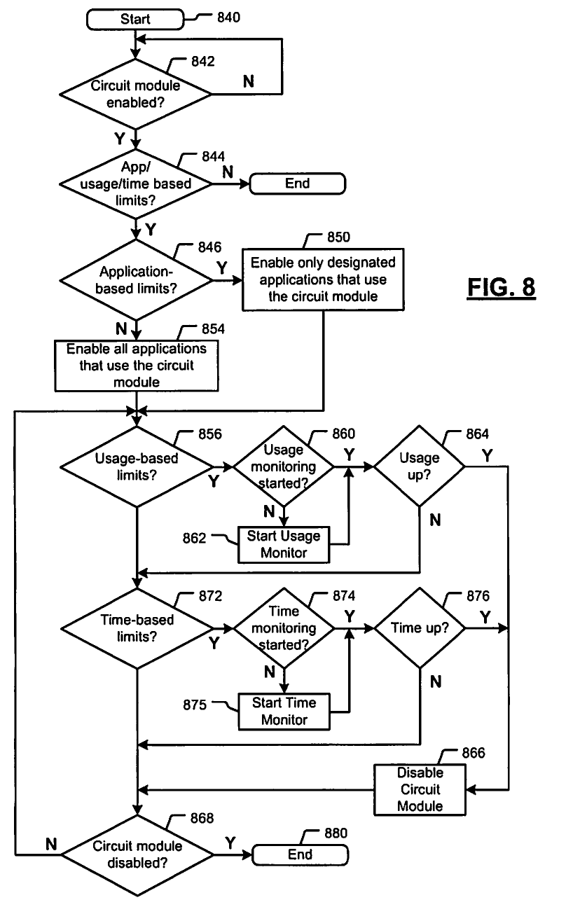

Referring now to FIG. 8, a method for controlling the use of an initially disabled circuit module according to the present disclosure is shown. The disabled circuit module may be enabled in a variety of ways. For example, the disabled circuit module may be enabled for use with all of the second applications 566 and with no time-based or data-based usage restrictions. Alternately, the disabled circuit module may be enabled for use with certain ones of the second applications 566 and not others of the second applications 566. Alternately, the disabled circuit module may be enabled for a predetermined time and/or a predetermined amount of data throughput.

The method begins in FIG. 8 with step 840. In step 842, the method determines whether the initially disabled circuit module 558 has been enabled. If step 842 is true, control continues with step 844. In step 844, control determines whether there are application limits, usage limits and/or time limits for using the now-enabled circuit module 558.

In step 846, control determines whether there are application-based limits on the enable data. If the enable data designates that only certain ones of the second applications can be used, control continues with step 850 and enables only designated ones of the second applications for use with the enabled circuit module. If the enable data does not limit use based the type of application, control continues with step 854 and all of the second applications are enabled. Control continues from steps 850 and 854 with step 856.

In step 856, control determines whether there are usage-based limits. If step 852 is true, control continues with step 860 where control determines whether the usage monitor was previously started. In step 860 is false, the usage monitor is started in step 862. In step 864, control determines whether usage is up. Usage may be based on a predetermined number of sessions, a predetermined amount of data transferred and/or other criteria. If step 864 is false, control continues with step 872. If step 864 is true, control continues with step 866 and the circuit module is disabled. In step 868, control determines whether the circuit module has been disabled. If step 868 is false, control returns to step 856. If step 868 is true, control ends with step 870.

If step 856 is false, control continues with step 872 and determines whether there are time-based limits for using the circuit module. In step 874, control determines whether the time monitor was previously started. In step 874 is false, the time monitor is started in step 875. In step 876, control determines whether time is up. If step 876 is false, control continues with step 868. If step 876 is true, control continues with step 866 and the circuit module is disabled.

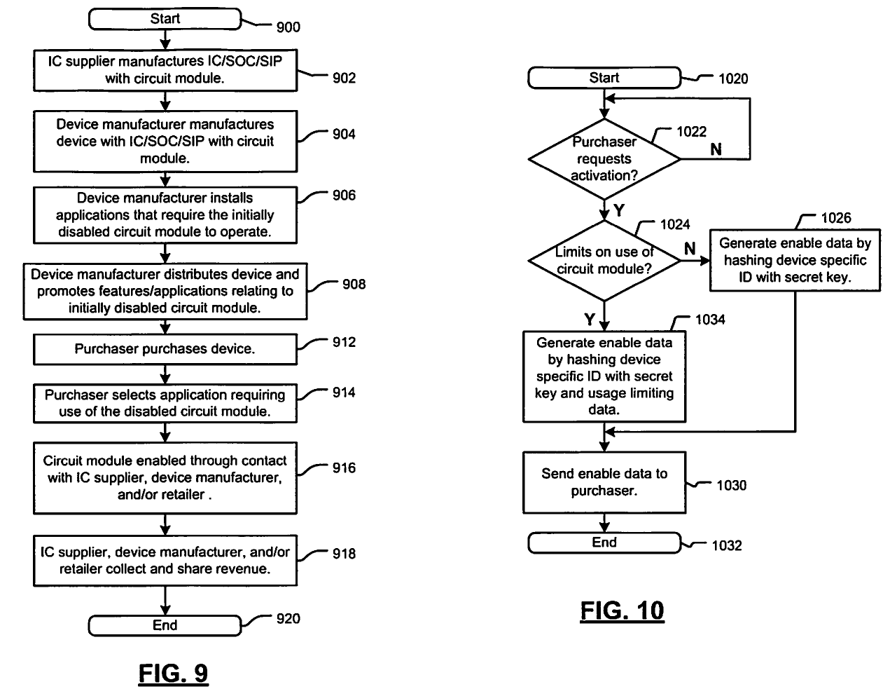

Referring now to FIG. 9, a method for distributing the device of FIG. 5 is shown. Control begins with step 900. In step 902, the IC supplier manufactures an IC/SOC/SIP with the initially disabled circuit module. In step 904, the device manufacturer manufactures the device with the initially disabled circuit module. In step 906, the device manufacturer installs applications that require the circuit module to operate. Alternately, the applications can be provided at the time of and/or after enablement of the circuit module.

In step 908, the device manufacturer distributes the device and promotes features and applications relating to the circuit module. In step 912, the purchaser purchases the device. In step 914, the purchaser launches the application that requires the disabled circuit to be enabled. In step 916, the circuit module is enabled as described herein. In step 918, the IC supplier and/or device manufacturer collects and shares revenue associated with the enabled circuit module. If a data service is involved, revenue sharing with a data service provider may occur. The method ends in step 920.

As can be appreciated, when the purchaser launches the application, the device may not be supported by a data service (such as a WiFi service provider). If the request is made using the data service, the data service may initially allow the request even though the device is a guest without data privileges. When the circuit module is enabled, the data service may also be initiated and the data service provider may share in the revenue with the IC supplier, the device manufacturer and/or the retailer.

Referring now to FIG. 10, a method for creating enable data according to the present disclosure is shown. The method begins with step 1020. In step 1022, the method determines whether the purchaser requests activation. If step 1022 is false, the method returns to step 1022. If step 1022 is true, the method determines whether there are limits on use of the requested circuit module in step 1024. If step 1024 is false, control continues with step 1026 and generates enable data by hashing a specific ID for the device with a key that is used to enable the circuit module. If step 1024 is true, control continues with step 1034 and generates enable data by hashing the device specific ID and usage limit limiting data with the secret key. The usage limiting data may include the application-specific limits, the time limits and/or the usage limits. Control continues from steps 1026 and 1034 with step 1030. In step 1030, the method includes sending enable data to the purchaser. As previously mentioned, alternative methods of creating enable data may be used including, for example, sharing of a secret key and public key cryptography.

It should be understood that the term “purchaser” as used herein is not necessarily limited to an end user of a device. A purchaser may include any entity or party that is part of a product development and distribution chain.

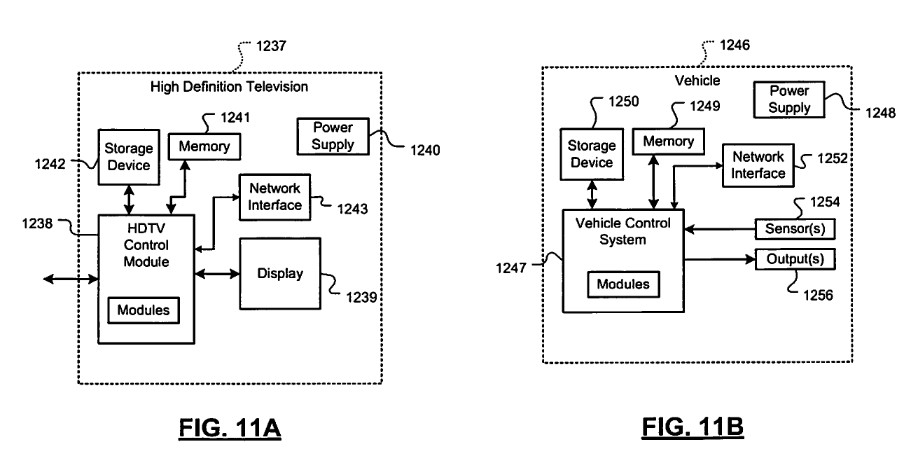

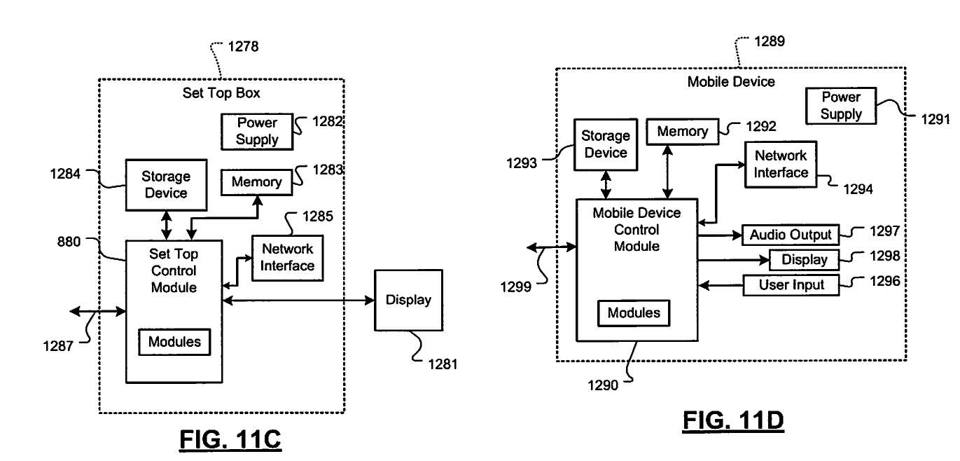

Referring now to FIGS. 11A-11D, various other exemplary implementations incorporating the teachings of the present disclosure are shown.

Referring now to FIG. 11A, the teachings of the disclosure can be implemented to enable and disable one or more modules 1236 of a high definition television (HDTV) 1237 as described above. The HDTV 1237 includes an HDTV control module 1238, a display 1239, a power supply 1240, memory 1241, a storage device 1242, a network interface 1243, and an external interface 1245. If the network interface 1243 includes a wireless local area network interface, an antenna (not shown) may be included.

The HDTV 1237 can receive input signals from the network interface 1243 and/or the external interface 1245, which can send and receive data via cable, broadband Internet, and/or satellite. The HDTV control module 1238 may process the input signals, including encoding, decoding, filtering, and/or formatting, and generate output signals. The output signals may be communicated to one or more of the display 1239, memory 1241, the storage device 1242, the network interface 1243, and the external interface 1245.

Memory 1241 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1242 may include an optical storage drive, such as a DVD drive, and/or a hard disk drive (HDD). The HDTV control module 1238 communicates externally via the network interface 1243 and/or the external interface 1245. The power supply 1240 provides power to the components of the HDTV 1237.

Referring now to FIG. 11B, the teachings of the disclosure may be implemented to enable and disable one or more modules 1236 of a vehicle 1246 as described above. The vehicle 1246 may include a vehicle control system 1247, a power supply 1248, memory 1249, a storage device 1250, and a network interface 1252. If the network interface 1252 includes a wireless local area network interface, an antenna (not shown) may be included. The vehicle control system 1247 may be a powertrain control system, a body control system, an entertainment control system, an anti-lock braking system (ABS), a navigation system, a telematics system, a lane departure system, an adaptive cruise control system, etc.

The vehicle control system 1247 may communicate with one or more sensors 1254 and generate one or more output signals 1256. The sensors 1254 may include temperature sensors, acceleration sensors, pressure sensors, rotational sensors, airflow sensors, etc. The output signals 1256 may control engine operating parameters, transmission operating parameters, suspension parameters, etc.

The power supply 1248 provides power to the components of the vehicle 1246. The vehicle control system 1247 may store data in memory 1249 and/or the storage device 1250. Memory 1249 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1250 may include an optical storage drive, such as a DVD drive, and/or a hard disk drive (HDD). The vehicle control system 1247 may communicate externally using the network interface 1252.

Referring now to FIG. 11C, the teachings of the disclosure can be implemented to enable and disable one or more modules 1236 of a set top box 1278 as described above. The set top box 1278 includes a set top control module 1280, a display 1281, a power supply 1282, memory 1283, a storage device 1284, and a network interface 1285. If the network interface 1285 includes a wireless local area network interface, an antenna (not shown) may be included.

The set top control module 1280 may receive input signals from the network interface 1285 and an external interface 1287, which can send and receive data via cable, broadband Internet, and/or satellite. The set top control module 1280 may process signals, including encoding, decoding, filtering, and/or formatting, and generate output signals. The output signals may include audio and/or video signals in standard and/or high definition formats. The output signals may be communicated to the network interface 1285 and/or to the display 1281. The display 1281 may include a television, a projector, and/or a monitor.

The power supply 1282 provides power to the components of the set top box 1278. Memory 1283 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1284 may include an optical storage drive, such as a DVD drive, and/or a hard disk drive (HDD).

Referring now to FIG. 11D, the teachings of the disclosure can be implemented to enable and disable one or more modules 1236 of a mobile device 1289 as described above. The mobile device 1289 may include a mobile device control module 1290, a power supply 1291, memory 1292, a storage device 1293, a network interface 1294, and an external interface 1299. If the network interface 1294 includes a wireless local area network interface, an antenna (not shown) may be included.

The mobile device control module 1290 may receive input signals from the network interface 1294 and/or the external interface 1299. The external interface 1299 may include USB, infrared, and/or Ethernet. The input signals may include compressed audio and/or video, and may be compliant with the MP3 format. Additionally, the mobile device control module 1290 may receive input from a user input 1296 such as a keypad, touchpad, or individual buttons. The mobile device control module 1290 may process input signals, including encoding, decoding, filtering, and/or formatting, and generate output signals.

The mobile device control module 1290 may output audio signals to an audio output 1297 and video signals to a display 1298. The audio output 1297 may include a speaker and/or an output jack. The display 1298 may present a graphical user interface, which may include menus, icons, etc. The power supply 1291 provides power to the components of the mobile device 1289. Memory 1292 may include random access memory (RAM) and/or nonvolatile memory.

Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1293 may include an optical storage drive, such as a DVD drive, and/or a hard disk drive (HDD). The mobile device may include a personal digital assistant, a media player, a laptop computer, a gaming console, or other mobile computing device.

It should be further understood that other types of consumer electronic devices, such as, personal computers, laptop computers, digital picture frames, etc. may be implemented to include features as described in the present disclosure. As can be appreciated, while certain components of the integrated circuits described above may be described as modules, these components may also comprise circuit modules. In other words, these components may include shared circuits and circuits that are unique to the component. These unique circuits of the circuit modules may be located at distinct locations of the integrated circuit. The unique circuits may be selectively enabled as described above.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A device comprising:
an integrated circuit comprising:
N first circuit modules each having an enabled state, wherein N is an integer greater than zero; and
M second circuit modules each having a disabled state, wherein M is an integer greater than zero; and
a control module that outputs upgrade data including identification of said M second circuit modules for enabling said M second circuit modules, respectively, and that allows selection and enablement of at least one of said M second circuit modules by a purchaser based on payment of at least a corresponding one of M prices associated with said M second circuit modules.

2. The device of claim 1 further comprising:
a display for displaying said upgrade data output by said control module; and
a user interface for selecting said at least one of said M second circuit modules.

3. The device of claim 1 further comprising:
an external interface,
wherein said control module transmits identification data for at least one of said integrated circuit and said device via said external interface and receives said upgrade data based on said identification data.

4. The device of claim 1 further comprising:
an external interface,
wherein said control module transmits at least one of selection and payment data via said external interface for said at least one of said M second circuit modules and receives module enabling data for said at least one of said M second circuit modules via said external interface.

5. The device of claim 4 wherein said control module selectively enables said at least one of said M second circuit modules based on said module enabling data.

6. The device of claim 1 wherein said M second circuit modules are arranged on said integrated circuit at M distinct locations.

7. The device of claim 3 wherein said external interface communicates with a remote server, which is associated with one of a manufacturer of said integrated circuit, a manufacturer of said device and a retailer of said device.

8. The device of claim 4 wherein said module enabling data is selected from a group consisting of a driver, a password and enabling code.

9. The device of claim 3 wherein said control module automatically generates said identification data without user input.

10. The device of claim 3 further comprising a user interface, wherein said control module generates said identification data based on user input to said user interface.

11. The device of claim 3 wherein said external interface is integrated with said integrated circuit.

12. The device of claim 1 wherein said control module is integrated with said integrated circuit.

13. A cellular phone comprising the device of claim 1 wherein at least one of said M second circuit modules is selected from a group consisting of a cellular third-generation (3G) transceiver module, a multiple in multiple out (MIMO) transceiver module, a global positioning system (GPS) module, a Bluetooth module, a wireless local area network (WLAN) module, and a frequency modulated (FM) tuner module.

14. A method comprising:
providing an integrated circuit within a device;
enabling N first circuit modules of said integrated circuit, wherein N is an integer greater than zero;
disabling M second circuit modules of said integrated circuit, wherein M is an integer greater than zero;
providing upgrade data to be made available to a purchaser, wherein said upgrade data includes identification of said M second circuit modules; and
allowing selection and enablement of at least one of said M second circuit modules by said purchaser based on payment of at least a corresponding one of M prices associated with said M second circuit modules.

15. The method of claim 14 further comprising:
configuring said integrated circuit to display said upgrade data on a display of said device; and
configuring said integrated circuit to allow said at least one of said M second circuit modules to be enabled via a user interface of said device.

16. The method of claim 14 further comprising:
providing an external interface;
configuring said integrated circuit to transmit identification data for at least one of said integrated circuit and said device via said external interface; and
configuring said integrated circuit to receive said upgrade data via said external interface based on said identification data.

17. The method of claim 14 further comprising:
providing an external interface;
configuring said integrated circuit to transmit at least one of selection and payment data via said external interface for said at least one of said M second circuit modules; and
configuring said integrated circuit to receive module enabling data for said at least one of said M second circuit modules via said external interface.

18. The method of claim 17 further comprising configuring said integrated circuit to selectively enable said at least one of said M second circuit modules based on said module enabling data.

19. The method of claim 14 further comprising arranging said M second circuit modules on said integrated circuit at M distinct locations.

20. The method of claim 17 wherein said external interface communicates with a remote server, and wherein the remote server is associated with one of a manufacturer of said integrated circuit, a manufacturer of said device and a retailer of said device.

21. The method of claim 17 wherein said module enabling data is selected from a group consisting of a driver, a password and enabling code.

22. The method of claim 16 further comprising configuring said integrated circuit to automatically generate said identification data without user input.

23. The method of claim 16 further comprising configuring said integrated circuit to generate said identification data based on user input to a user interface.

24. The method of claim 16 wherein said external interface is integrated with said integrated circuit.

25. The method of claim 14 further comprising selecting at least one of said M second circuit modules from a group consisting of a cellular third-generation (3G) transceiver module, a multiple in multiple out (MIMO) transceiver module, a global positioning system (GPS) module, a Bluetooth module, a wireless local area network (WLAN) module, and a frequency modulated (FM) tuner module.

26. A method comprising:
incorporating an integrated circuit including (N+M) circuit modules into a device;
enabling N of said circuit modules, wherein N is an integer greater than zero;
disabling M of said circuit modules, wherein M is an integer greater than zero;
establishing one or more pricing levels based on said N circuit modules that are enabled and said M circuit modules that are disabled; and
configuring said integrated circuit to allow a purchaser to upgrade said device after taking possession of said device by enabling at least one of said M circuit modules based on payment for said at least one of said M circuit modules.

27. The method of claim 26 wherein said configuring said integrated circuit further comprises:
configuring said integrated circuit to:
send identification data for at least one of said integrated circuit and said device; and
receive upgrade description data for enabling said at least one of said M circuit modules based on said identification data.

28. The method of claim 27 wherein said configuring said integrated circuit further comprises:
configuring said integrated circuit to:
send at least one of upgrade selection and payment data;
receive module enabling data based on said at least one of said upgrade selection and payment data; and
enable said at least one of said M circuit modules based on said upgrade module enabling data.

29. The method of claim 27 wherein said upgrade description data includes pricing data for enabling said at least one of said M disabled modules.

30. The method of claim 27 wherein said upgrade description data includes upgrade description data for said at least one of said M disabled modules.

31. The method of claim 28 wherein said module enabling data is selected from a group consisting of a driver, a password and enabling code.

32. The method of claim 27 further comprising configuring said integrated circuit to automatically generate said identification data for said device without user input.

33. The method of claim 27 further comprising configuring said integrated circuit to generate said identification data based on user input to said device.

34. The method of claim 26 further comprising sharing upgrade revenue that is received by at least one of a retailer and a device manufacturer.

35. The method of claim 26 further comprising selecting at least one of said M second circuit modules from a group consisting of a cellular third-generation (3G) transceiver module, a multiple in multiple out (MIMO) transceiver module, a global positioning system (GPS) module, a Bluetooth module, a wireless local area network (WLAN) module, and a frequency modulated (FM) tuner module.

36. The method of claim 26 further comprising selling said integrated circuit to at least one of a device manufacturer and a retailer with S modules enabled and T modules disabled, where S and T are integers, S is not equal to N, T is not equal to M and wherein (S+T) is equal to (N+M).

37. A device comprising:
a first circuit module that is initially disabled when said device is delivered to a purchaser and that includes an activation module that is adapted to selectively enable said first circuit module after said delivery; and
a control module that controls operation of at least one function of said device, that executes at least one first application that is enabled, and that executes at least one of T second applications that require enablement of said first circuit module, where T is an integer greater than zero,
wherein said control module comprises an activation managing module that communicates with said activation module to activate said first circuit module based on enable data and identification (ID) data associated with said device.

38. The device of claim 37 wherein said activation managing module recovers a key from said enable data and transmits said key to said activation module to enable said first circuit module and to allow execution of said at least one of T second applications.

39. The device of claim 37 wherein said first circuit module is implemented by a first integrated circuit and wherein said control module is implemented by a second integrated circuit.

40. The device of claim 37 wherein said first circuit module and said control module are implemented by a first integrated circuit.

41. The device of claim 37 wherein said first circuit module performs a network-related function.

42. The device of claim 37 wherein said first circuit module comprises a wireless network interface.

43. The device of claim 37 wherein when an attempt to launch at least one of said T second applications is made before said first circuit module is enabled, said control module outputs a message with one or more instructions for enabling said first circuit module.

44. The device of claim 37 wherein said activation managing module further comprises a time limiting module that limits use of said first circuit module to a predetermined period after enablement of said first circuit module.

45. The device of claim 37 wherein said activation managing module further comprises a usage limiting module that limits usage of said first circuit module to at least one of a predetermined number of sessions after enablement of said first circuit module and a predetermined amount of data exchanged after enablement of said first circuit module.

46. The device of claim 37 wherein T is greater than 1, and wherein said activation managing module limits use of said first circuit module to S of said T second applications, where S is an integer less than T.

47. The device of claim 38 wherein said enable data comprises said key that is hashed with said ID data.

48. The device of claim 38 wherein said enable data comprises said ID data and usage limiting data that are hashed with said key.

49. The device of claim 38 wherein said enable data is received after said purchaser pays a price associated with use of said first circuit module.

50. The device of claim 37 further comprising:
a display that displays purchaser upgrade selections that are output by said control module; and
a user interface that is used to select at least one of said purchaser upgrade selections.

51. The device of claim 37 further comprising an external interface that communicates data between said control module and a remote server to upgrade said device, wherein said remote server is associated with one of a manufacturer of said control module, a manufacturer of said device and a retailer of said device.

52. A camera comprising the device of claim 37 and the camera further comprising:
an image processing module that processes image data,
wherein said first circuit module comprises a wireless network interface.

53. The device of claim 49 wherein said first circuit module provides a wireless network interface and wherein said price further includes payment for data services associated with a wireless network.

54. The device of claim 38 wherein said first circuit module comprises a wireless network interface, wherein said enable data is transmitted one of in band and out of band on a wireless network and wherein said first circuit module wirelessly receives said enable data.

55. A method comprising:
incorporating a first circuit module that is initially disabled into a device;
configuring said first circuit module to be selectively enabled after delivery to a purchaser;
loading at least one first enabled application on the device;
loading T second applications on the device, execution of said T second applications requiring enablement of said first circuit module after delivery to the purchaser, where T is an integer greater than zero; and
configuring said device to enable said first circuit module based on enable data and identification (ID) data associated with said device.

56. The method of claim 55 further comprising:
configuring said device to recover a key from said enable data based on said ID data; and
configuring said device to use said key to enable use of said first circuit module and to execute one or more of said T second applications.

57. The method of claim 55 further comprising configuring said first circuit module to perform a network-related function.

58. The method of claim 55 further comprising configuring said first circuit module to provide a wireless network interface.

59. The method of claim 55 further comprising configuring said device to display a message with one or more instructions for enabling said first circuit module when an attempt to launch at least one of said T second applications is made before said first circuit module is enabled.

60. The method of claim 55 further comprising configuring said device to limit use of said first circuit module to a predetermined period after enablement.

61. The method of claim 55 further comprising configuring said device to limit usage of said first circuit module to at least one of a predetermined number of sessions after enablement and a predetermined amount of data exchanged after enablement.

62. The method of claim 55 wherein T is greater than 1, and further comprising configuring said device to limit use of said first circuit module to S of said T second applications, where S is an integer less than T.

63. The method of claim 56 further comprising configuring said device to hash said key with said ID data to generate said enable data.

64. The method of claim 56 further comprising configuring said device to hash said key with said ID data and usage limiting data to generate said enable data.

65. The method of claim 56 further comprising configuring said device to receive said enable data after said purchaser pays a price associated with use of said first circuit module.

66. The method of claim 55 further comprising configuring said device to:
display upgrade selections; and
allow selection of at least one of said upgrade selections.

67. The method of claim 55 further comprising configuring said device to exchange data between said device and a remote server using an external interface to upgrade said device, wherein said remote server is associated with one of a manufacturer of said first circuit module, a manufacturer of said device and a retailer of said device.

68. The method of claim 65 further comprising:
configuring said device to provide a wireless network interface; and
wherein payment for wireless data services associated with a wireless network is included in said price.

69. The method of claim 56 further comprising configuring said device to receive said enable data one of in band and out of band on a wireless network.
